(19) United States
(12) Patent Application Publication
(10) Pub. No.: US 2001/0004813 A1
(43) Pub. Date: Jun. 28, 2001

(54) System and method for removing harmful organic substances from an enclosure

(76) Inventor: David E. Hedman, Ojai, CA (US)

Correspondence Address: Scott W. Kelley, Esq., KELLY BAUERSFELD LOWRY & KELLY, LLP, Suite 1650, 6320 Canoga Avenue, Woodland Hills, CA, 91367, US

(21) Appl. No.: 09/768,680

(22) Filed: Jan. 24, 2001

Related U.S. Application Data
(63) Continuation-in-part of application No. 09/321,915, filed on May 28, 1999.

(51) Int. Cl. A01M 1/20

(52) U.S. Cl. 43/132.1

(57) ABSTRACT

A system and method for removing harmful biological and organic substances from an enclosed structure, vehicle or container includes protecting heat-sensitive articles within the enclosure. The structure is enclosed with a tent having an air inlet and outlet. A plurality of temperature probes are positioned at predetermined locations within the structure. The air within the structure is heated to a predetermined temperature of between a 110° F. and 400° F. to kill organisms and cause harmful substances in the structure to migrate into the ambient air. The heated air carrying the harmful substances is vented from the structure and passed through a filter to remove the harmful substances from the heated air. The system effectively kills insects, molds, viruses and bacteria and reduces the levels of allergens and volatile organic compounds in the structure.

### RELATED APPLICATION

This application is a continuation-in-part of U.S. application Ser. No. 09/321,915, filed May 28, 1999.

### BACKGROUND OF THE INVENTION

The present invention relates to methods of sanitizing buildings and other enclosed spaces. More particularly, the present invention relates to a system and method for killing and removing insects, bacteria, viruses, fungi, toxic molds, and volatile organic compounds.

A large number of methods have been developed for killing insects, such as termites, in buildings. The most widely used method is tenting the building, then filling the building with a toxic gas for a period of time sufficient to kill termites or other selected insects. This method is effective for killing termites and other insects. However, this method generally requires 12 hours to be effective, requiring building occupants to move out and businesses to be closed for approximately a three day period to insure proper venting of toxic material and/or gas. Tenting the building with heavy tarpaulins requires workers to walk and arrange the tarpaulins on the roof, often damaging the roof system. Food and medications must be placed in sealed containers or removed. Generally the entire building must be treated, even if the infestation is localized.

Because of the disadvantages of the toxic gas method, various other techniques of varying effectiveness have been developed, using heated air or very cold air to kill termites. Typical of these is the method disclosed by Charles Forbes in U.S. Pat. No. 4,817,329, in which wood destroying insects, e.g., termites, are killed by applying a heated gas, such as heated air, to wooden surfaces until the building surfaces are heated to a temperature, typically about 120° F. to 135° F. Temperatures for killing other insects are said to be surprisingly close to this range. This method has been found to be very effective for killing termites.

However, this method, using the described temperatures, is not effective for other organisms, such as fungi, and toxic molds such as, but not limited to, aspergillus oryzae, aspergillus terreus, aspergills versicolor, cladosporium hergbarum, stachybotrys chartarum, penicillium aurantiogriseum, pencillium chrsogenum, pencillium gladrum and fusarium oxysporum. Further, many insects such as mites, fungi, molds and the like are a serious health hazard even when dead. Many people are allergic to the dust-like remains, i.e., allergens, of these organisms that can also cause serious health problems. This is a particular problem to persons suffering from asthma, bronchitis, pneumoconious and other respiratory ailments, and is a common contributing factor to sick building syndrom (SBS).

Also, volatile organic compounds (VOCs) have been implicated as a possible cause of SBS. VOCs can originate from a variety of sources. Commercial examples include by-products of printing shop operations, office machine repairs, blueprint production, photographic processing and food service operations. In residences, such VOCs can include hobbyist products, cosmetics, perfumes, personal hygiene products, aerosol sprays, tobacco smoking, and even small emissions from the bodies of the occupants. Off gassing of VOCs is often a common by-product of various building/construction materials, for example paints, adhesives, plastics, carpeting, etc.

Such VOCs are implicated with SBS for mostly two reasons. First, the health effects from exposure to VOCs are consistent with SBS, ranging from irritant effects such as unpleasant odors and mucous membrane irritation, through general systemic effects such as fatigue, nausea, and difficulty concentrating. In addition, they may be of importance because some of them have been shown to have carcinogenic or adverse reproductive effects. Second, indoor concentrations of VOCs, particularly in new buildings, are often greatly elevated with respect to outdoor VOC concentrations. In fact, indoor VOC concentrations have typically been found to be two to ten times higher then outdoor concentrations, and indoor concentrations as much as 100 times higher than outdoor concentrations have been reported in new buildings.

Accordingly, there is a need for a system and method for killing and removing biological organisms and reducing odors and volatile organic compounds in enclosures such as commercial and residential buildings, boats, vehicles and product containers. Such a method should be non-toxic and performed in a relatively short amount of time. Such a method should also effectively kill and remove a large proportion of the dead organisms and substantially reduce volatile organic compounds. The present invention fulfills these needs and provides other related advantages.

### SUMMARY OF THE INVENTION

The present invention resides in a system which removes harmful organic substances from an enclosure, such as a building, vehicle, container or other enclosed structure. The system typically includes a tent capable of adequately enclosing the structure. The tent has an air inlet and an air outlet. Means for heating air, such as a gas or electric device, is provided to heat the air to a predetermined temperature of between 110° F. and 400° F. Means for placing and distributing the heated air through the tent inlet, such as a blower and duct work, and into the structure are provided. A plurality of temperature probes are placed at predetermined locations within the structure. A vacuum device, such as a fan, creates a negative pressure at the outlet of the tent for venting. Preferably, a filter, such as a HEPA filter, is placed between the outlet and the vacuum device to remove the harmful substances from the air.

Means are also provided for protecting heat-sensitive articles within the enclosed structure. Such means can include insulated mats which cover the articles, and fans or the like which redirect the flow of hot air away from such articles or areas.

In use, the structure is enclosed with the tent. Heat-sensitive articles within the structure are either covered with the insulated mat or means for redirecting the heated air are placed adjacent to these articles. The temperature probes are positioned at predetermined locations within the structure. The air within the structure is heated to a predetermined temperature of between 110° F. and 400° F. to cause the harmful substances in the structure to migrate into the ambient air. The air can be heated directly within the structure, however, preferably the heated air is injected into the structure using blowers or the like. The temperature from the probes are monitored until the predetermined temperature is achieved. The heated air carrying the harmful substances is vented from the structure. Preferably, a negative pressure is created using the vacuum device to facilitate the removal of the heated air and substances from the structure. This removed air is passed through the filter so as to remove the harmful substances from the heated air and prevent their introduction into the environment.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic diagram showing components of the system of the present invention; and

FIG. 2 is a flow diagram of the method of the present invention.

### DETAILED DESCRIPTION OF THE PREFERRED EMBODIMENT

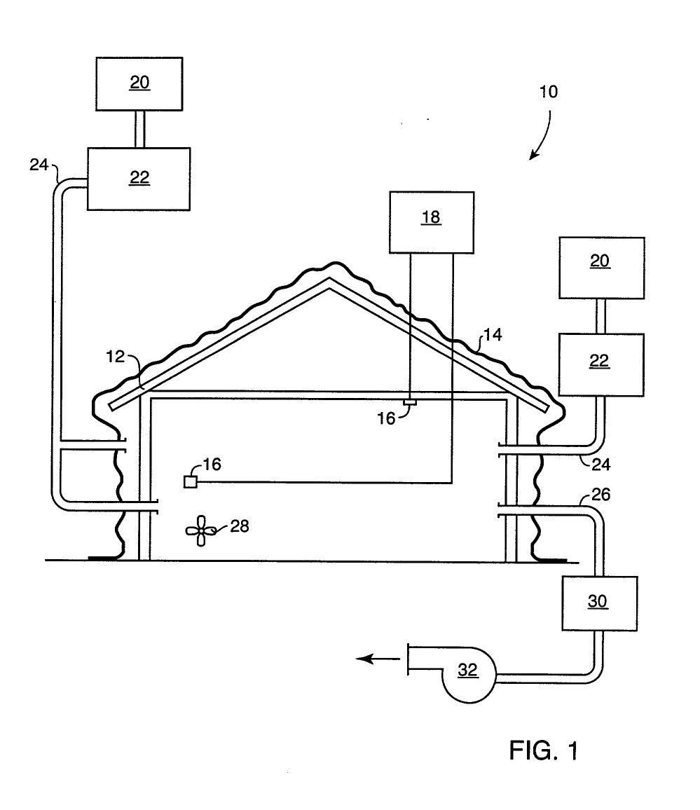

Referring to FIG. 1, there is seen a schematic diagram showing the components of the system of the present invention, referred to generally by the reference number 10, in use treating an enclosed structure 12. Enclosed structure 12 may be a commercial or residential building, boat, vehicle or product container. A covering enclosure 14, such as, but not limited to conventional tenting may be required to treat the exterior surface of the enclosed structure 12 or used to facilitate the process as described herein.

A plurality of temperature sensors 16 are positioned at predetermined locations to monitor the temperature of the structure 12. Typically, these sensors 16 have thin, elongated tips that can be adhered to or pushed into materials to be heated or into suitably sized holes drilled into such materials so as to measure the surface and/or internal temperature. The sensors 16 may be wired to a console 18 which displays and records the temperature at each sensor 16 in real time. Alternatively, the sensors 16 may be wireless and transmit a signal to the console 18. Typical sensors 16, as for way of example and not by way of limiting, include thermal couples, thermistors, or the like connected to a computer and/or a strip chart recorder console 18.

One or more heaters 20 heat air to a predetermined temperature. The air is heated to at least a temperature lethal to the organisms to be destroyed. For a more complete disinfection, the air temperature is preferably raised to at least about 155° F., with optimum results generally be achieved with temperatures in the range of about 110° F. to 400° F.

Any suitable heater 20 may be used. A gas burning heating device 20, such as a conventional propane heater, is preferred as being particularly efficient in heating air. Any other heating arrangement, such as electrical devices, may be used if desired.

Heated air from the one or more heaters 20 is directed through blower 22 (which may, if desired, be a component of the heater 20) which injects the hot air into the enclosed structure 12 through at least one inlet duct 24. Generally, a plurality of inlet ducts 24 will be used to achieve the optimum distribution of hot air throughout the enclosed structure 12. The inlet ducts 24 preferably include variable flow dampers and may be moved while the system is in operation to achieve uniform temperatures in all areas of the structure being treated, as sensed by sensors 16 and observed at console 18. Preferably, heated air is directed into an enclosed structure faster than it is exhausted, thereby creating a positive pressure inside the enclosure. This positive pressure, in addition to the heat, kill organisms and cause harmful substances and odors, such as VOCs, to migrate into the ambient air within the structure.

When utilized, at least one outlet duct 26 is provided to allow the air to vent from the structure 12. While it is preferred that enclosed structure 12 be maintained at a pressure slightly above atmospheric pressure as the hot air brings the building elements up to the desired surface and penetration temperatures, the positive pressure differential also allows the hot air to vent through open windows, doors, etc. and carries away VOCs upon venting. In addition, vacuuming of surfaces and/or wiping surfaces and aggressively moving the air within the enclosure may be utilized to enhance the removal of harmful biological and organic substances, such as allergens.

Fans 28 may be strategically placed within the structure 12 to selectively move the air away from predetermined heat-sensitive articles or areas of the structure in which such an elevated temperature is not desired. If the entire structure 12 is to be treated and there is no concern for heat-sensitive articles, or such articles can be removed from the structure 12, these fans 28 can instead be used to direct the heated air throughout the structure 12 so that the structure 12 is heated uniformly.

Although the structure 12 can be vented by opening a window or door of the structure 12, preferably, the structure 12 is sealed using the tent-like structure 14. The heated air carrying the harmful substances is allowed to vent through outlet duct 26. Preferably, the heated air is passed through an air scrubber 30 for removing the remains of the organisms and VOCs from the air to prevent them from reaching the environment. Such an air scrubber 30 typically includes a filter, such as a high efficiency particulate arrestance (HEPA) filter. Other filters such as charcoal filters or UV filters may be employed as well.

For optimum effectiveness, it is often desirable to increase air flow rates by adding a vacuum device, such as a blower 32 or other air extraction means, either upstream or downstream of the air scrubber 30 to aid in extracting the air from enclosed structure 12. This forced extraction also increases the efficiency of filtering of the air by the air scrubber 30.

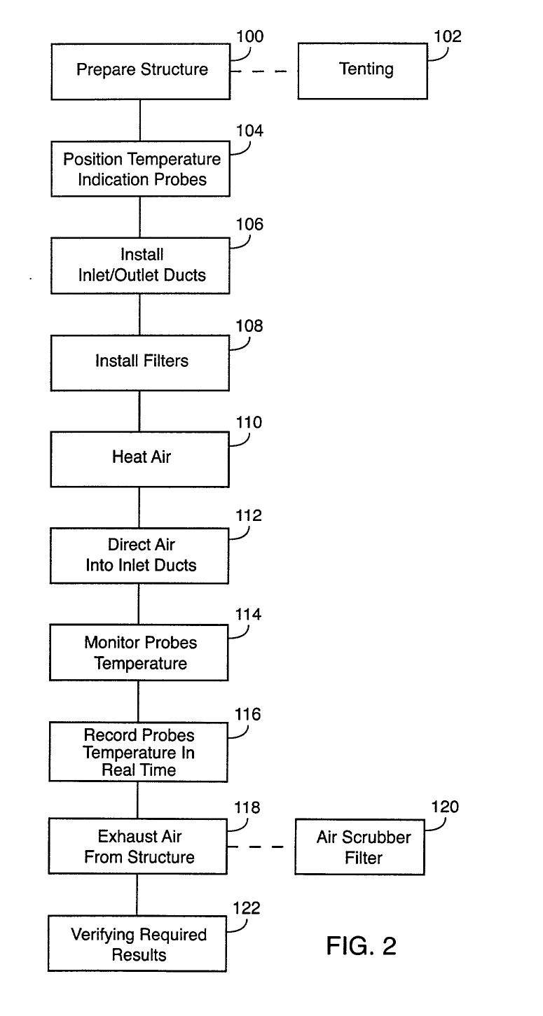

With reference to FIG. 2, in the operation of the system of the invention, the first step is to prepare the structure, as indicated in block (100). This basically involves removing all heat-sensitive items from the enclosure or, in some cases, covering heat sensitive items, such as electronic devices and plastic items, with thermal insulation material. All material that has a flash/melt point or below the maximum temperature to be used (such as candles, lipstick, etc.) must be removed. The preparation of the structure 12 may also include the installation of the tent structure 14 (102).

Next, the plurality of temperature indicating probes 16 are placed in predetermined locations within the enclosed structure 12 as indicated in block (104) to assure that the required temperature levels are achieved. In some cases the probes 16 can be read directly, although preferably they are connected by wires or wireless means to the console 18, so that all probes 16 can be monitored conveniently and the data recorded in real time.

When the enclosed structure 12 is sealed, at least one inlet duct 24 and at least one outlet duct 26 are then installed as indicated in block (106). Generally, a plurality of inlet ducts 24 is preferred. Although each duct 24 may enter the enclosed structure 12 separately, the use of one inlet duct 24 connected to a manifold from which plural ducts extend to predetermined locations within the enclosed structure 12 is preferred. Ducts 24 may enter the structure 12 through any suitable opening, such as an open window or door with the remainder of the window or door blocked by a panel.

The appropriate air scrubbing filters 30 and vacuum devices 32 for facilitating the removal of the heated air and filtering the harmful substances therefrom, is installed, as indicated in block (108).

When the components of the system 10 have been properly prepared and positioned, the air is heated to the appropriate temperature (110), and directed into the inlet ducts 24 (112).

Flow of the heated air through the enclosed structure 12 may range in time from a few hours to several days to provide optimum results. During this time, the temperature probes 16 are monitored (114) and these results recorded in real time (116) to ensure that the intended areas within the structure 12 are properly treated.

The heated air which has been circulated through the structure 12 is allowed to exhaust (118). As described above, this vented air preferably passes through an air scrubber filter (120) to remove the remains of the destroyed organisms and VOCs. The filter system will inherently impose some back pressure on the outlet duct 26 and enclosed structure 12. While back pressure is desirable to ensure the proper exposure and penetration of the heated air to all parts of the enclosed structure 12, excessive back pressure should be avoided. Therefore, it is generally desirable that an air extraction system, such as the vacuum device 32, be employed to facilitate the venting of air from the structure 12 to limit the back pressure and facilitate removal of the harmful substances from the air.

At any time during system operation, the inlet and outlet ducts 24 and 26 may be moved to assure uniform temperatures throughout the structure, as indicated by the temperature probes 16 and temperature monitoring console 18. As a last step of the process, the required and desired results are verified (122) by inspecting the structure 12.

This entire process may often be completed in five to twelve hours, allowing a business to be closed for only one day or a residential structure to be fully treated during a typical work or school day. However, in certain circumstances, such as in the case of large structures or high levels of harmful substances within the structure, the process may be extended to several days or more to ensure that the structure is properly treated. It has been found that while harmful organisms are killed and removed during this process, the reduction of the VOCs actually continues for some time after treatment. Placing a filtering system within the structure and/or opening a window to allow the structure 12 to properly vent is believed to be adequate to remove these residual compounds.

Although an embodiment has been described in detail for purposes of illustration, various modifications may be made without departing from scope and spirit of the invention. Accordingly, the invention is not to be limited, except as by dependent claims.

What is claimed is:

1. A method for removing harmful biological and organic substances from an enclosed structure, comprising the steps of:
positioning a plurality of temperature probes at predetermined locations within the structure;
heating ambient air within the structure to a predetermined temperature of between 110° F. and 400° F. to cause the harmful substances in the structure to be destroyed or migrate into the ambient air;
monitoring the temperature from the probes until the predetermined temperature is achieved;
venting the heated air carrying the harmful substances from the structure; and
filtering at least a portion of the harmful substances from the heated air.

2. The method of claim 1, including the step of placing and distributing heated air into the enclosed structure.

3. The method of claim 1, wherein a high efficiency particulate arrestance filter is used to filter the harmful substances from the heated air.

4. The method of claim 1, including the venting step includes the step of creating a negative pressure to remove the heated air from the structure.

5. The method of claim 1, including the step of enclosing the structure with a tent having an air inlet for the addition of heated air, and an air outlet for venting the heated air carrying the harmful substances.

6. The method of claim 1, including the step of protecting heat-sensitive articles within the structure.

7. The method of claim 6, including the step of covering the articles with an insulated mat.

8. The method of claim 6, including the step of directing the flow of heated air away from the article.

9. The method of claim 1, including the step of vacuuming or wiping surfaces within the structure.

10. The method of claim 9, including the step of aggressively moving air within the structure to aerosolize the biological and organic substances to facilitate their removal during the filtering step.

11. A method for removing harmful biological and organic substances from an enclosed structure, comprising the steps of:
positioning a plurality of temperature probes at predetermined locations within the structure;
placing and distributing heated air of a predetermined temperature of between 110° F. and 400° F. into the structure to cause the harmful substances in the structure to be destroyed or migrate into the ambient air;
monitoring the temperature from the probes until the predetermined temperature is achieved;
creating a negative pressure to vent the heated air carrying the harmful substances from the enclosure; and
filtering at least a portion of the harmful substances from the heated air using a high efficiency particulate arrestance filter.

12. The method of claim 11, including the step of enclosing the structure with a tent having an air inlet for the addition of heated air, and an air outlet for venting the heated air carrying the harmful substances.

13. The method of claim 11, including the step of protecting heat-sensitive articles within the structure.

14. The method of claim 13, including the step of covering the articles with an insulated mat.

15. The method of claim 13, including the step of directing the flow of heated air away from the article.

16. The method of claim 11, including the steps of vacuuming or wiping surfaces within the structure and aggressively moving air within the structure to aerosolize the biological and organic compounds to facilitate their removal during the filtering step.

17. A system for removing harmful biological and organic substances from an enclosed structure, comprising:
a tent capable of adequately enclosing the structure, the tent having an air inlet and an air outlet;
means for heating air to a predetermined temperature of between 110° F. and 400° F.;
means for placing and distributing the heated air through the tent inlet and into the enclosure;
a plurality of temperature probes placed at predetermined locations within the structure;
a vacuum device for creating a negative pressure at the outlet of the tent; and
a filter disposed between the outlet and the vacuum device.

18. The system of claim 17, wherein the means for heating comprises a gas or electric heating device.

19. The system of claim 17, wherein the means for placing and distributing comprises an air blower device.

20. The system of claim 17, wherein the filter comprises a high efficiency particulate arrestance filter.

21. The system of claim 17, including means for protecting heat-sensitive articles within the enclosed structure.

22. The system of claim 21, wherein the protecting means comprises fans for redirecting the flow of heated air away from heat-sensitive articles within the structure.

23. The system of claim 21, wherein the protecting means comprises insulated mats placed over heat-sensitive articles within the structure.
